(19) United States
(12) Patent Application Publication
(10) Pub. No.: US 2006/0125591 A1
(43) Pub. Date: Jun. 15, 2006

(54) [HIGH VOLTAGE TRANSFORMER]

(75) Inventors: Ching-Sheng Yang, Taipei (TW); Su-Hua Wu, Taipei (TW); Shu-Chen Wang, Taipei (TW)

Correspondence Address: TAIPEI MULTIPOWER ELECTRONICS CO., LTD., 2F-4, NO. 148, SEC. 4, CHUNG HSIAO EAST ROAD, TAIPEI, TW

(73) Assignee: TAIPEI MULTIPOWER ELECTRONICS CO., LTD., Hsin-Tien City, Taipei Hsien (TW)

(21) Appl. No.: 10/905,088

(22) Filed: Dec. 15, 2004

(51) Int. Cl. H01F 27/30

(52) U.S. Cl. 336/208

(57) ABSTRACT

Disclosed is a high voltage transformer, which includes two electrically insulative brackets, each having a longitudinal insertion hole and a transverse opening across the insertion hole, primary windings and secondary windings respectively wound round the brackets, two first iron cores each having a plurality of extension arms respectively inserted into the insertion hole of each bracket, and one second iron core inserted through the transverse opening of each bracket and stopped between the extension arms of the first iron cores to have each primary winding to use with the corresponding secondary winding a respective magnetic circuit.

### BACKGROUND OF THE INVENTION

1. Field of the Invention

The present invention relates to a transformer and more particularly, to a high voltage transformer, which enables each primary winding to use with the corresponding secondary winding a respective magnetic path so as to provide a stable electric energy output to the connected lamp tube for durable use.

2. Description of the Related Art

German scientist Karl Ferdinand Braun developed the first controllable CRT in 1897. However, it wasn't until the late 1940s that CRTs were used in the first television sets. Nowadays, various new display devices including TFT LCDs, PDPs, FPDs, etc. have been developed and have appeared on the market. It is predicated that TFT LCDs will soon completely take the place of CRTs on market.

Currently, the backlight of a TFT LCD uses a number of CCFLs (Cold Cathode Fluorescent Lamps). In order to drive these CCFLs, each CCFL uses one respective circuit (electronic ballast). Because a CCFL discharges electricity, it produces negative resistance. When multiple CCFLs are connected in parallel to a transformer, the transformer can only turn on one CCFL. Therefore, people usually put a rectifying capacitor between CCFLs and the respective transformers so that the CCFLs that are connected in parallel can be simultaneously turned on. However, because each CCFL uses a respective circuit (electronic ballast), the manufacturing cost of the TFT LCD is high, and the size of the TFT LCD cannot be reduced to meet the market trend toward light, thin, short and small.

In order to eliminate the aforesaid drawbacks, transformer manufacturers developed a one-to-multiple compact design of transformer. According to this design, a primary winding and multiple secondary windings are provided at two sides of a magnetic circuit, and a driving circuit is connected to the primary winding to provide electric energy to the primary winding, for enabling each secondary winding to output electric energy to a respective lamp via a respective capacitor. According to this design, one transformer is capable of driving multiple lamps. The use of such a transformer in a TFT LCD greatly saves the manufacturing cost and size of the TFT LCD. However, this design cannot eliminate magnetic interference between windings, and the secondary windings may output different amount of electric energy to the connected lamps, resulting in insufficient brightness of the lamps or damage to the lamps. In order to eliminate this problem, another design of high voltage transformer is developed. As illustrated in FIG. 11, the high voltage transformer comprises two electrically insulative brackets A arranged in parallel, primary windings A1 and secondary windings A2 respectively wound round the electrically insulative brackets A, and two U-shaped iron cores B respectively inserted into the electrically insulative brackets A from two sides and set into abutment to form a magnetic path. This design of high voltage transformer can drive two lamp tubes at a time. This design of high voltage transformer uses multiple primary windings and secondary windings to drive multiple lamp tubes. However, because the windings use one common magnetic path, magnetic interference will occur between each two adjacent windings, resulting in unstable power output and uneven brightness of the connected lamp tubes. Further, the use of one common magnetic path by multiple primary windings and secondary windings will cause magnetic saturation, resulting in loss of magnetization and overheat of the iron core set, and the power capacity of the high voltage transformer will drop.

Further, the arrangement of the multiple primary windings and secondary windings greatly increase length of the magnetic path, thereby lowering the occurrence of leakage inductance. However, for full-wave or half-wave bridge type application, a high voltage transformer must use leakage inductance to achieve the desired resonance frequency. In order to obtain the desired resonance, the leakage inductance must reach a certain value.

Therefore, it is desirable to provide a high voltage transformer that eliminates the aforesaid drawbacks.

### SUMMARY OF THE INVENTION

The present invention has been accomplished under the circumstances in view. It is therefore the main object of the present invention to provide a high voltage transformer, which uses the iron core set to separate the windings and to prevent magnetic interference between two adjacent windings, for enabling one primary winding to use with a corresponding secondary winding a respective magnetic path to provide a stable power output, eliminating the problems of magnetic saturation, loss of magnetization or overhead of the iron core set.

It is another object of the present invention to provide a high voltage transformer, which has the iron core set so arranged to shorten the magnetic path and to increase the leakage inductance, providing the desired resonance frequency.

To achieve these and other objects of the present invention, the high voltage transformer comprises an electrically insulative base, the electrically insulative base comprising at least one electrically insulative bracket, each electrically insulative bracket having an insertion hole extending through two distal ends thereof; a plurality of primary windings and a plurality of second windings respectively wound round the at least one electrically insulative bracket; an iron core set, the iron core set comprising at least one first iron core, each first iron core having a plurality of extension arms respectively inserted into the insertion hole of each electrically insulative bracket, and one second iron core attached to the at least one first iron core; wherein each electrically insulative bracket has an opening transversely extended across the respective insertion hole between two windings at the respective electrically insulative bracket for accommodating the second iron core for enabling the second iron core to be stopped against the extension arms of each first iron core.

### BRIEF DESCRIPTION OF THE DRAWINGS

FIG. 1 is an exploded view of a high voltage transformer according to a first embodiment of the present invention.

FIG. 2 is an elevational assembly view of the high voltage transformer according to the first embodiment of the present invention.

FIG. 3 is an exploded view of a high voltage transformer according to a second embodiment of the present invention.

FIG. 4 is an elevational assembly view of the high voltage transformer according to the second embodiment of the present invention.

FIG. 5 is an exploded view of a high voltage transformer according to a third embodiment of the present invention.

FIG. 6 is an elevational assembly view of the high voltage transformer according to the third embodiment of the present invention.

FIG. 7 is an exploded view of a high voltage transformer according to a fourth embodiment of the present invention.

FIG. 8 is an elevational assembly view of the high voltage transformer according to the fourth embodiment of the present invention.

FIG. 9 is an exploded view of a high voltage transformer according to a fifth embodiment of the present invention.

FIG. 10 is an elevational assembly view of the high voltage transformer according to the fifth embodiment of the present invention.

FIG. 11 is an exploded view of a high voltage transformer according to the prior art.

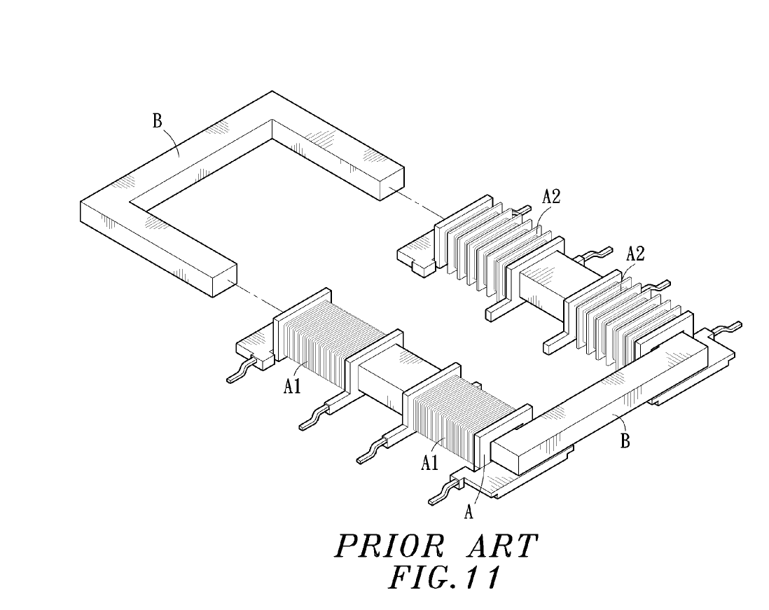

### DETAILED DESCRIPTION OF THE PREFERRED EMBODIMENT

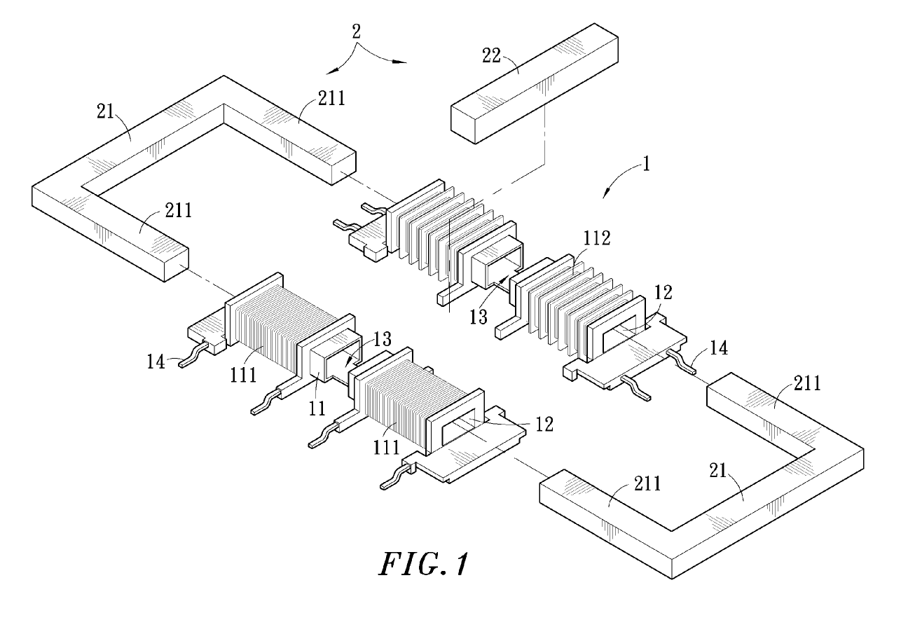

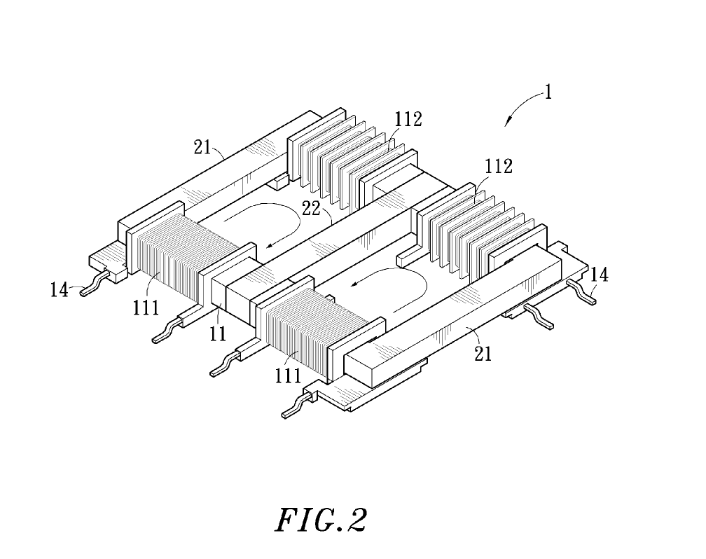

Referring to FIGS. 1 and 2, a high voltage transformer in accordance with the first embodiment of the present invention is shown comprised of a base 1 and an iron core set 2.

The base 1 is made of electrically insulative material, comprising two parallel brackets 11, a plurality of primary windings 111 respectively wound round one of the two brackets 11, and a plurality of secondary windings 112 respectively wound round the other of the two brackets 11. Each bracket 11 has a longitudinally extended insertion hole 12, and at least one opening 13 transversely extended across the insertion hole 12 and separating each two adjacent windings 111 or 112. According to this embodiment, there are two primary windings 111 and two secondary windings 112; each bracket 11 has one opening 13 transversely extended across the respective insertion hole 12 to keep the respective windings 111 or 112 apart. Further, a plurality of lead wires 14 are respectively installed in the brackets 11 and respectively electrically connected to the ends of the windings 111 and 112.

The iron core set 2 includes two first iron cores 21 and one second iron core 22. Each first iron core 21 has two extension arms 211 arranged in parallel.

During the assembly process of the first embodiment of the present invention, the extension arms 211 of the two first iron cores 21 are respectively inserted into the insertion hole 12 of each of the two brackets 11 from two sides, and the second iron core 22 is inserted into the openings 13 and stopped between the extension arms 211 of the two first iron cores 21.

When in use, electric current is connected to the primary windings 111 through the lead wires 14 at the bracket 11 holding the primary windings 111 to induce with the secondary windings 112 by means of the magnetic path formed of the first iron cores 21 and the second iron core 22, thereby changing the voltage of the electric current for output through the secondary windings 112 via the lead wires 14 at the bracket 11 holding the secondary windings 112. By means of arrangement of the second iron core 22, each primary winding 111 uses with the corresponding secondary winding 112 a respective magnetic path (see the arrowhead signs in FIG. 2), preventing interference between the primary windings 111 or the secondary windings 112 and therefore stable current output is obtained from the secondary windings 112. Further, because each primary winding 111 uses with the corresponding secondary winding 112 a respective magnetic path, the invention prevents magnetic saturation due to the use of one common magnetic path for multiple primary and secondary windings 11, 12 and also prevents loss of magnetization and overheat of the iron core set 2, thereby improving the power capacity of the high voltage transformer.

Further, the design of the second iron core 22 shortens the magnetic path, thereby improving the permeability of the iron core set 2 and increasing the leakage inductance of the whole assembly to meet the requirements for resonance frequency for high voltage transformer.

Further, the first iron cores 21 and second iron core 22 of the iron core set 2 can be made of silicon steel plates.

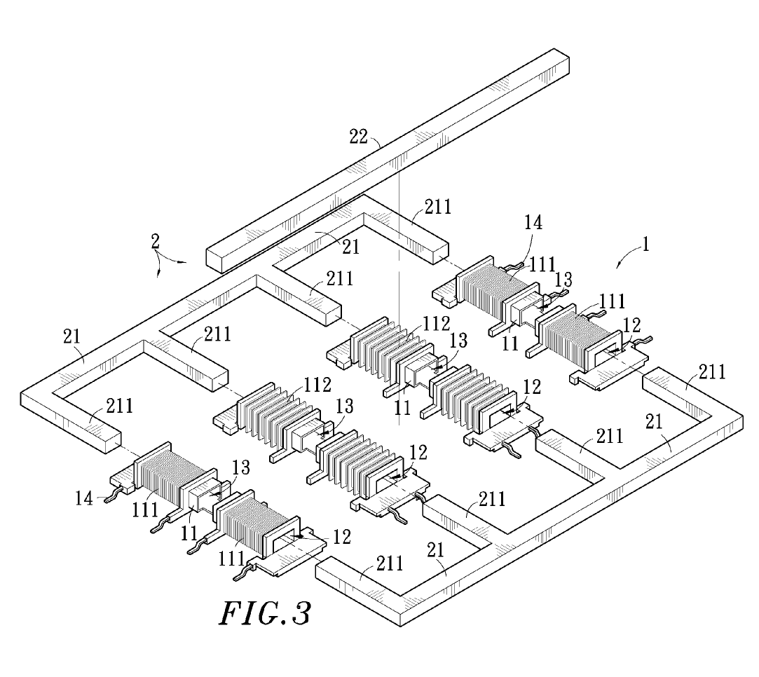

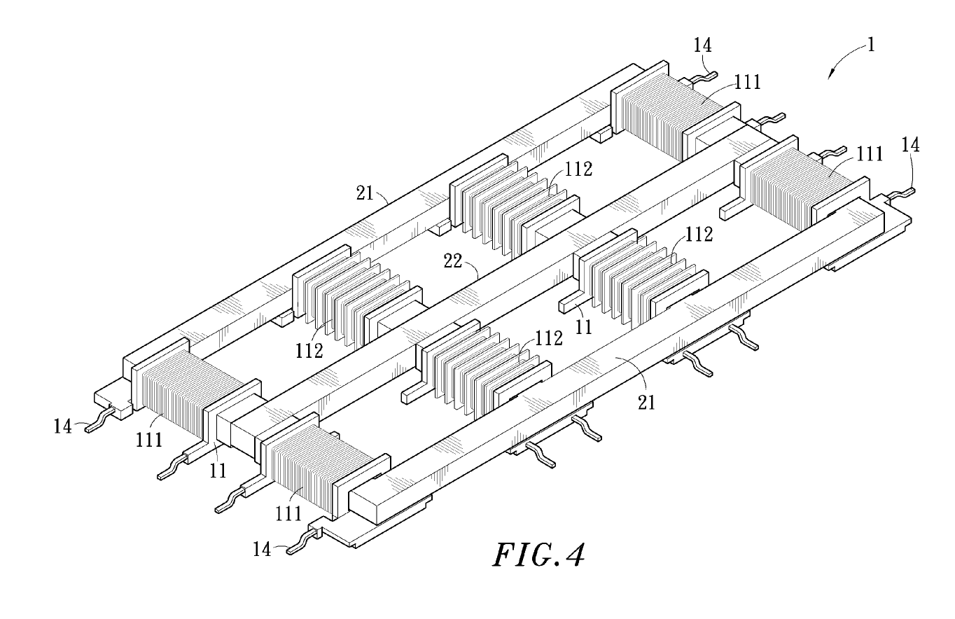

FIGS. 3 and 4 show a high voltage transformer according to the second embodiment of the present invention. According to this embodiment, the high voltage transformer is comprised of a base 1 and an iron core set 2. The base 1 is comprised of four brackets 11 arranged in parallel. The brackets 11 according to this second embodiment have the same structure as described in the aforesaid first embodiment. The first iron cores 21 of the iron core set 2 each have a plurality of extension arms 211 arranged in parallel and respectively inserted into the insertion holes 12 of the brackets 111 from two sides. The second iron core 22 is inserted into the openings 13 of the brackets 111 and stopped between the extension arms 211 of the two first iron cores 21. This embodiment has multiple secondary windings 112 to provide output current.

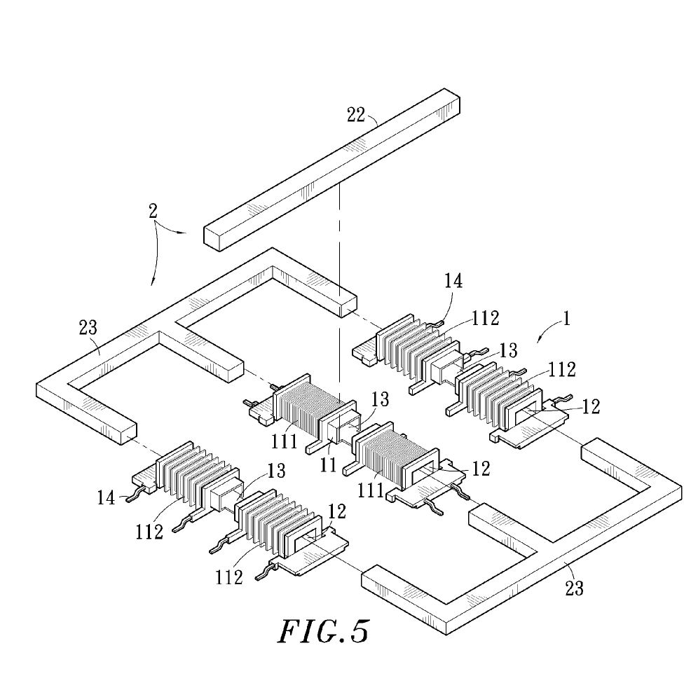

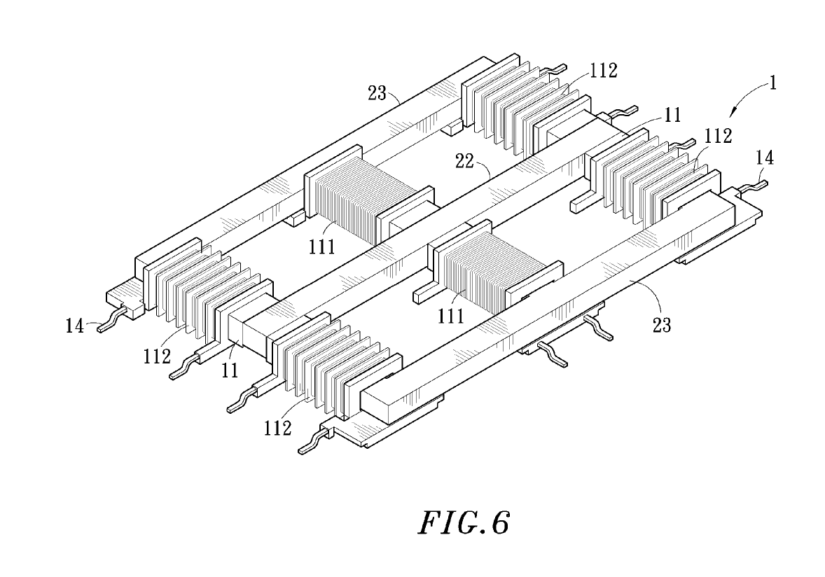

FIGS. 5 and 6 show a high voltage transformer according to the third embodiment of the present invention. According to this embodiment, the high voltage transformer is comprised of a base 1 and an iron core set 2. The base 1 is comprised of three brackets 111 arranged in parallel. Each of the two side brackets 111 is mounted with two secondary windings 112 at two sides of the respective opening 13. The middle bracket 11 is mounted with two primary windings 111 at two sides of the respective opening 13. The iron core set 2 comprises two E-shaped first iron cores 23 respectively inserted into the insertion holes 12 of three brackets 11 of the base 1 from two sides, and one second iron core 22 inserted into the openings 13 of the brackets 11 and stopped between the two E-shaped first iron cores 23. This embodiment has the same advantages of the aforesaid first embodiment of the present invention.

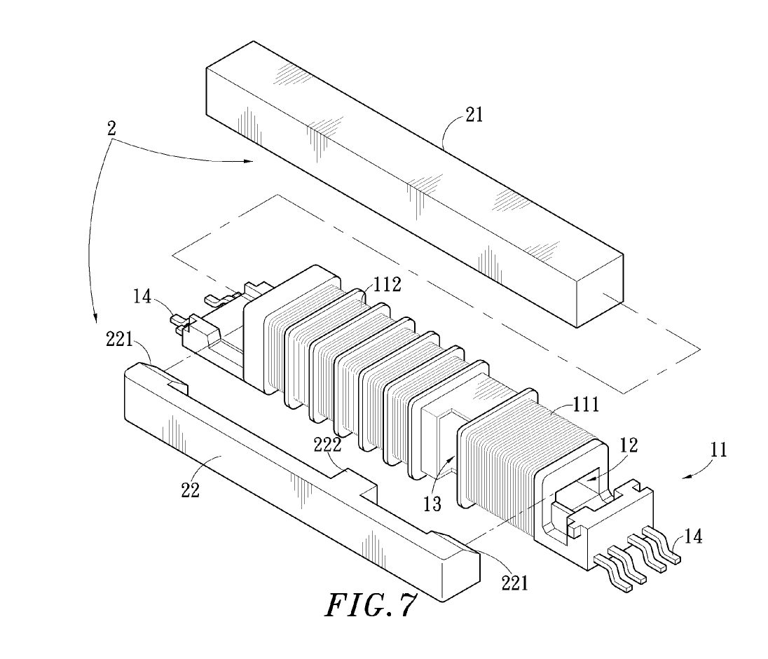

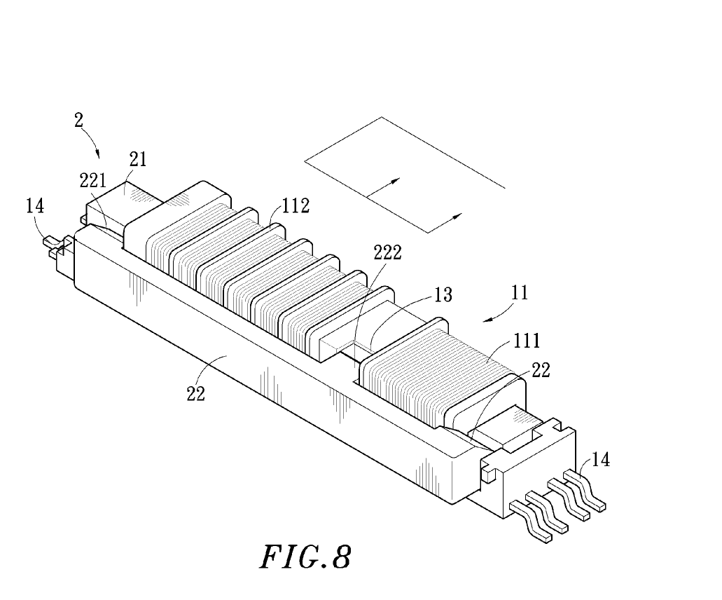

FIGS. 7 and 8 show a high voltage transformer according to the fourth embodiment of the present invention. According to this embodiment, the high voltage transformer comprises an elongated bracket 11, which has a longitudinal insertion hole 12 and an opening 13 transversely extended across the longitudinal insertion hole 12, a primary winding 111 wound round the bracket 11 at one side relative to the opening 13, a secondary winding 112 wound round the bracket 12 at the other side relative to the opening 13, a plurality of lead wires 14 respectively installed in the bracket 11 and electrically connected to the primary winding 111 and the secondary winding 112, and an iron core set 2. The iron core set 2 comprises a first iron core 21 inserted into the insertion hole 12 of the bracket 11, and a second iron core 22 attached to one lateral side of the bracket 11 and kept in contact with the first iron core 21. The second iron core 22 has two end butts 221 respectively stopped at the ends of the first iron core 21, and a middle butt 222 engaged into the opening 13 and stopped against one lateral side of the first iron core 21.

During use of the aforesaid fourth embodiment, electric current is connected through the lead wires 14 at one end of the bracket 11 to the primary winding 111 to induce with the secondary winding 112 by means of the magnetic path formed of the first iron core 21 and the second iron core 22, thereby changing the voltage of the electric current for output through the second winding 112 via the lead wires 14 at the other end of the bracket 11. The first iron core 21 forms with the second iron core 22 two magnetic paths, preventing interference between the primary winding 111 and the secondary winding 112. Therefore, this arrangement increases the permeability of the iron core set 2 and the leakage inductance of the whole assembly to meet the requirements for resonance frequency for high voltage transformer.

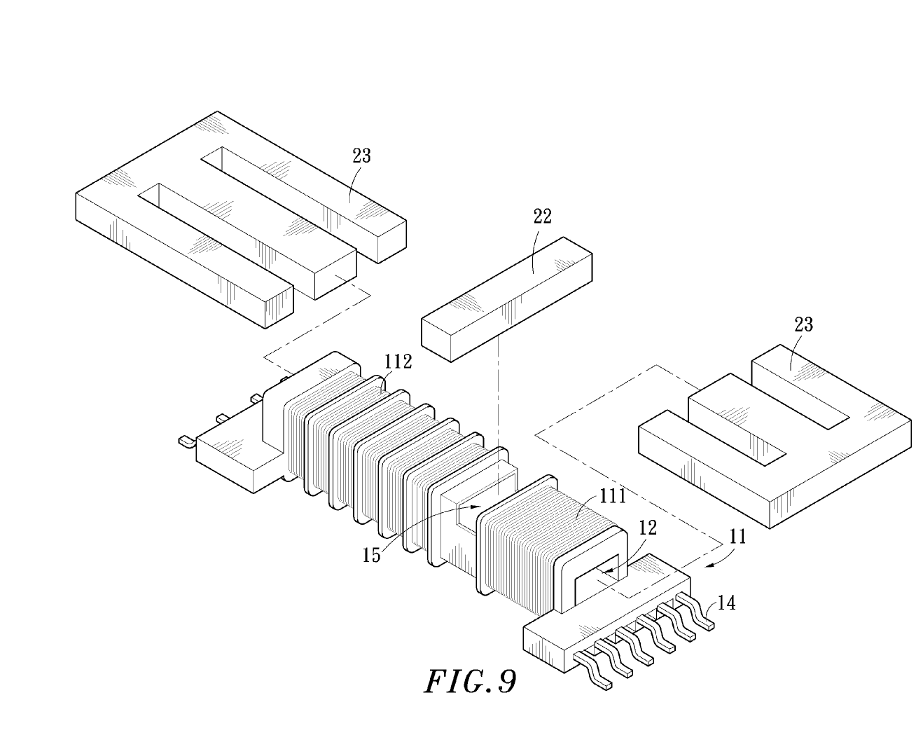

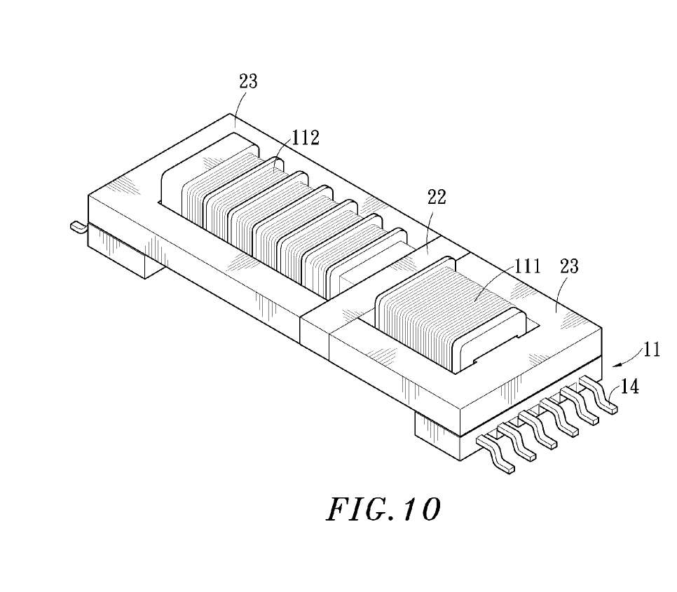

FIGS. 9 and 10 show a high voltage transformer according to the fifth embodiment of the present invention. This embodiment is substantially similar to the aforesaid fourth embodiment with the exception of the design of the iron core set 2. According to this embodiment, the iron core set 2 comprises two E-shaped first iron cores 23, and a second iron core 22. The two E-shaped first iron cores 23 are respectively inserted into the insertion hole 12 of the bracket 11, and the second iron core 22 is inserted through the opening 13 in the bracket 111 between the primary winding 111 and the second winding 112 and stopped between the E-shaped first iron cores 23. This embodiment has the same advantages as the aforesaid various embodiments.

As indicated above, the invention improves the drawbacks of the prior art design by means of the following features.

1. The second iron core is stopped between the first iron cores (or stopped against the first iron core) and set between the primary windings and the secondary windings (or the primary winding and the second winding) for enabling each primary winding to use with one secondary winding a respective magnetic path to prevent interference between windings and loss of magnetization and overheat of the iron core set, thereby improving the power capacity of the high voltage transformer.

2. The invention uses the second iron core to shorten the magnetic path and to increase the permeability of the iron core set, thereby increasing the leakage inductance of the whole assembly to meet the requirements for resonance frequency for high voltage transformer.

A prototype of high voltage transformer has been constructed with the features of FIGS. 1˜10. The high voltage transformer functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A high voltage transformer comprising:
an electrically insulative base, said electrically insulative base comprising at least one electrically insulative bracket, each said electrically insulative bracket having an insertion hole extending through two distal ends thereof;
a plurality of primary windings and a plurality of second windings respectively wound round said at least one electrically insulative bracket;
an iron core set, said iron core set comprising at least one first iron core, each said first iron core having a plurality of extension arms respectively inserted into the insertion hole of each said electrically insulative bracket, and one second iron core attached to said at least one first iron core;
wherein each said electrically insulative bracket has an opening transversely extended across the respective insertion hole between two windings at the respective electrically insulative bracket for accommodating said second iron core for enabling said second iron core to be stopped against the extension arms of each said first iron core.

2. The high voltage transformer as claimed in claim 1, further comprising a plurality of lead wires respectively electrically connected to said primary windings and said secondary windings and respectively extending out of two distal ends of each said brackets.

3. The high voltage transformer as claimed in claim 1, wherein said at least one first iron core and said second iron core are respectively made of silicon steel plates.

4. The high voltage transformer as claimed in claim 1, wherein said base comprises a plurality of electrically insulative brackets arranged in parallel.

5. A high voltage transformer comprising:
an electrically insulative bracket, said electrically insulative bracket having an insertion hole extending through two distal ends thereof;
a primary winding and at least one second winding respectively wound round said electrically insulative bracket;
an iron core set, said iron core set comprising a first iron core inserted through the insertion hole of said electrically insulative bracket, and a second iron core attached to one side of said electrically insulative bracket, said second iron core having two end butts respectively stopped against two distal ends of said first iron core outside the insertion hole of said electrically insulative bracket;
wherein said electrically insulative bracket has an opening transversely extended across said insertion hole between said primary winding and said at least one secondary winding; said second iron core has a middle butt engaged into said opening of said electrically insulative bracket and stopped against one side of said first iron core.

6. A high voltage transformer comprising:
an electrically insulative bracket, said electrically insulative bracket having an insertion hole extending through two distal ends thereof;
a primary winding and at least one second winding respectively wound round said electrically insulative bracket;
two E-shaped first iron cores respectively inserted into the insertion hole of said electrically insulative bracket from two sides;
wherein said electrically insulative bracket has an opening transversely extended across said insertion hole between said primary winding and said at least one secondary winding; a second iron core is inserted through said opening of said electrically insulative bracket and stopped between said two E-shaped first iron cores.
